(19) United States
(12) Patent Application Publication
(10) Pub. No.: US 2002/0181015 A1
(43) Pub. Date: Dec. 5, 2002

(54) Printing device media identification and tracking

(76) Inventor: Margo N. Whale, Kuna, ID (US)

Correspondence Address: HEWLETT-PACKARD COMPANY, Intellectual Property Administration, P.O. Box 272400, Fort Collins, CO, 80527-2400, US

(21) Appl. No.: 09/874,433

(22) Filed: Jun. 4, 2001

(51) Int. Cl. G06K 1/00; B41F 1/00

(52) U.S. Cl. 358/1.15; 358/1.1; 358/498

(57) ABSTRACT

A printing device routes print media for printing that has a recognizable media identifier, such as an image, a watermark, or a chemical substance that identifies the print media as a particular brand and/or brand type. A scanning device, such as an optical scanner or chemical detection device, scans the print media and recognizes a media identifier. Information corresponding to the total number of print media routed through a printing device, and the total number of a particular brand and/or type of print media, is maintained in a memory component. The memory component can be a component of the printing device, or the memory component can be integrated with a replaceable component of the printing device, such as a toner cartridge. The information can be routed to an information database via a network system, or via a replaceable component recycle program.

### TECHNICAL FIELD

This invention relates to determining marketing information from printing devices and, in particular, to retrieving data pertaining to print media from a printing device that recognizes different print media brands and brand types, and stores corresponding information for market and product analysis.

### BACKGROUND

There are many suppliers that distribute various brand names of print media, and each of the various brand name suppliers have different types of print media such as pre-printed forms, media of varying colors, and different sizes of print media. Typically, a user of a printing device uses various brands of print media. Often, a brand and type of print media is selected based on what is readily available to the user when acquiring the print media.

A manufacturer of printing devices typically recommends a particular brand of print media for use with the printing devices to obtain a high quality print output. In addition, different types of the particular brand of print media can be recommended to ensure that users of a printing device will receive an optimum print output from the printing device. Accordingly, a manufacturer of printing devices may also distribute its own brand of print media with various brand types that are designed to provide a high quality print output on all of the various brand types of print media that the manufacturer distributes.

Although a manufacturer can track its sales of printing devices individually, and its sales of print media individually, the manufacturer can not determine whether the related products are used in conjunction with each other. Specifically, a manufacturer of printing devices can not determine what percentage of the print media used in the printing devices was also distributed by the manufacturer. Being able to determine this information about a product market share in conjunction with a related product can help a manufacturer develop marketing strategies and product distribution schemes.

### SUMMARY

A printing device routes print media for printing within the printing device. The print media has a recognizable media identifier, such as an image, a watermark, or a chemical substance that identifies the print media as a particular brand and/or brand type.

An optical scanner is used to scan the print media and recognize a media identifier that is an image on the print media, or a watermark within the print media. A chemical detection device is used to scan the print media and recognize a media identifier that is a chemical substance on the print media.

Information corresponding to the total number of print media routed through a printing device, and the total number of a particular brand and/or type of print media, can be maintained in a memory component. The memory component can be a component of the printing device, or the memory component can be integrated with a replaceable component of the printing device, such as a toner cartridge. Additionally, the memory component can be a component of a computing device connected to the printing device.

The information can be routed to an information database via a network system, or via a replaceable component recycle program. Information stored in a memory component that is a component of the printing device, or a computing device, is routed to the information database via a network communications system. Information stored in a memory component that is integrated with a replaceable component of the printing device is routed to the information database by way of recycling the replaceable component.

For a manufacturer of printing devices that also distributes its own brand of print media with various brand types, the information can be used to determine what percentage of the print media used in the printing devices was also distributed by the manufacturer.

### BRIEF DESCRIPTION OF THE DRAWINGS

The same numbers are used throughout the drawings to reference like features and components.

FIG. 1 is block diagram that illustrates various components of an exemplary printing device.

FIG. 2 is an illustration of a toner cartridge having an integrated memory component.

FIG. 3 is block diagram that illustrates various components of an exemplary computing device.

FIG. 4 is an illustration of a print media having a media identifier.

FIG. 5 is an illustration of various components of an exemplary printing device.

FIG. 6 is a block diagram that illustrates components of a print media identification and tracking system in an exemplary network environment.

FIG. 7 is an illustration of a data structure that stores data retrieved from a memory component of a printing device.

FIG. 8 is a flow diagram that describes a method for identifying and tracking print media.

### DETAILED DESCRIPTION

Introduction

The following describes systems and methods for determining different print media brands and/or brand types used within printing devices. A user of a printing device has many options of print media, from many different suppliers, to use in the printing device. By being able to distinguish between different print media, a manufacturer of printing devices that also distributes its own brand of print media with various brand types can determine what percentage of the print media used in the printing devices was also distributed by the manufacturer. This information about a product market share in conjunction with a related product can help the manufacturer develop marketing strategies and product distribution schemes.

Exemplary Printer Architecture

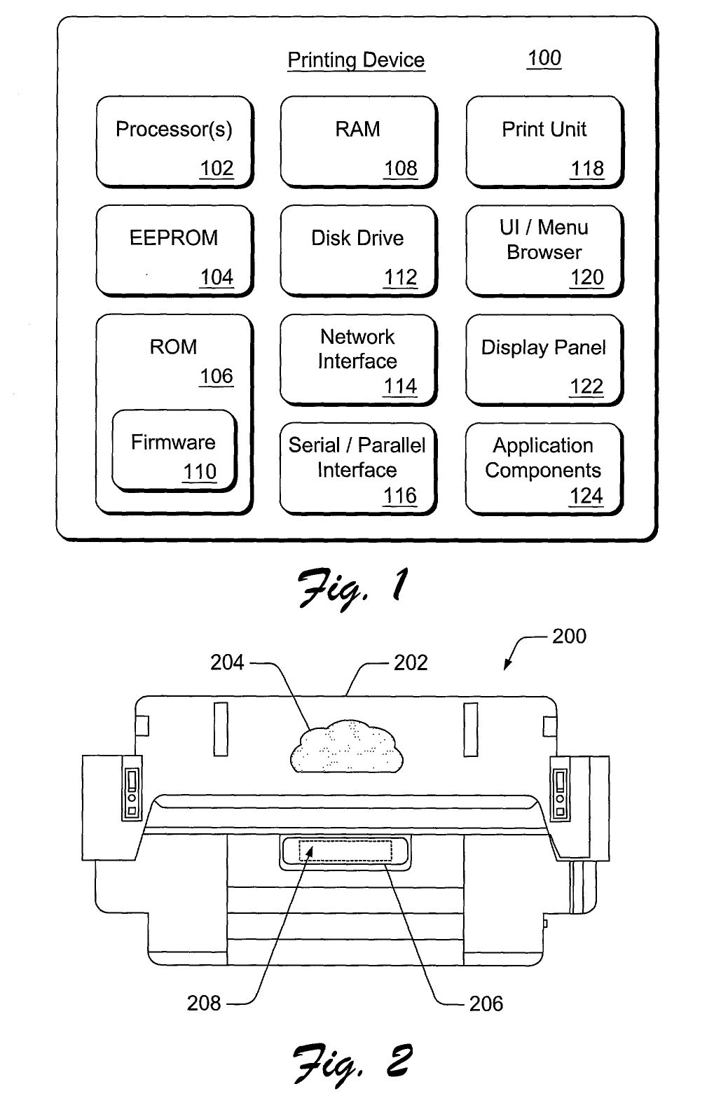

FIG. 1 illustrates various components of an exemplary printing device 100 that can be utilized to implement the inventive techniques described herein. Printer 100 includes one or more processors 102, an electrically erasable programmable read-only memory (EEPROM) 104, ROM 106 (non-erasable), and a random access memory (RAM) 108. Although printer 100 is illustrated having an EEPROM 104 and ROM 106, a particular printer may only include one of the memory components. Additionally, although not shown, a system bus typically connects the various components within the printing device 100.

The printer 100 also has a firmware component 110 that is implemented as a permanent memory module stored on ROM 106. The firmware 110 is programmed and tested like software, and is distributed with the printer 100. The firmware 110 can be implemented to coordinate operations of the hardware within printer 100 and contains programming constructs used to perform such operations.

Processor(s) 102 process various instructions to control the operation of the printer 100 and to communicate with other electronic and computing devices. The memory components, EEPROM 104, ROM 106, and RAM 108, store various information and/or data such as configuration information, fonts, templates, data being printed, and menu structure information. Although not shown, a particular printer can also include a flash memory device in place of or in addition to EEPROM 104 and ROM 106.

Printer 100 also includes a disk drive 112, a network interface 114, and a serial/parallel interface 116. Disk drive 112 provides additional storage for data being printed or other information maintained by the printer 100. Although printer 100 is illustrated having both RAM 108 and a disk drive 112, a particular printer may include either RAM 108 or disk drive 112, depending on the storage needs of the printer. For example, an inexpensive printer may include a small amount of RAM 108 and no disk drive 112, thereby reducing the manufacturing cost of the printer.

Network interface 114 provides a connection between printer 100 and a data communication network. The network interface 114 allows devices coupled to a common data communication network to send print jobs, menu data, and other information to printer 100 via the network. Similarly, serial/parallel interface 116 provides a data communication path directly between printer 100 and another electronic or computing device. Although printer 100 is illustrated having a network interface 114 and serial/parallel interface 11 6, a particular printer may only include one interface component.

Printer 100 also includes a print unit 118 that includes mechanisms arranged to selectively apply ink (e.g., liquid ink, toner, etc.) to a print media such as paper, plastic, fabric, and the like in accordance with print data corresponding to a print job. For example, print unit 118 can include a conventional laser printing mechanism that selectively causes toner to be applied to an intermediate surface of a drum or belt. The intermediate surface can then be brought within close proximity of a print media in a manner that causes the toner to be transferred to the print media in a controlled fashion. The toner on the print media can then be more permanently fixed to the print media, for example, by selectively applying thermal energy to the toner.

Print unit 118 can also be configured to support duplex printing, for example, by selectively flipping or turning the print media as required to print on both sides. Those skilled in the art will recognize that there are many different types of print units available, and that for the purposes of the present invention, print unit 118 can include any of these different types.

Printer 100 also includes a user interface and menu browser 120, and a display panel 122. The user interface and menu browser 120 allows a user of the printer 100 to navigate the printer's menu structure. User interface 120 can be indicators or a series of buttons, switches, or other selectable controls that are manipulated by a user of the printer. Display panel 122 is a graphical display that provides information regarding the status of the printer 100 and the current options available to a user through the menu structure.

Printer 100 can, and typically does include application components 124 that provide a runtime environment in which software applications or applets can run or execute. One exemplary runtime environment is a Java Virtual Machine (JVM). Those skilled in the art will recognize that there are many different types of runtime environments available. A runtime environment facilitates the extensibility of printer 100 by allowing various interfaces to be defined that, in turn, allow the application components 124 to interact with the printer.

General reference is made herein to one or more printing devices, such as printing device 100. As used herein, “printing device” means any electronic device having data communications, data storage capabilities, and/or functions to render printed characters and images on a print medium. A printing device may be a printer, fax machine, copier, plotter, and the like. The term “printer” includes, but is not limited to, laser printers, ink jet printers, dot matrix printers, dry medium printers, copiers, facsimile machines, and plotters. Although specific examples may refer to one or more of these printers, such examples are not meant to limit the scope of the claims or the description, but are meant to provide a specific understanding of the described implementations.

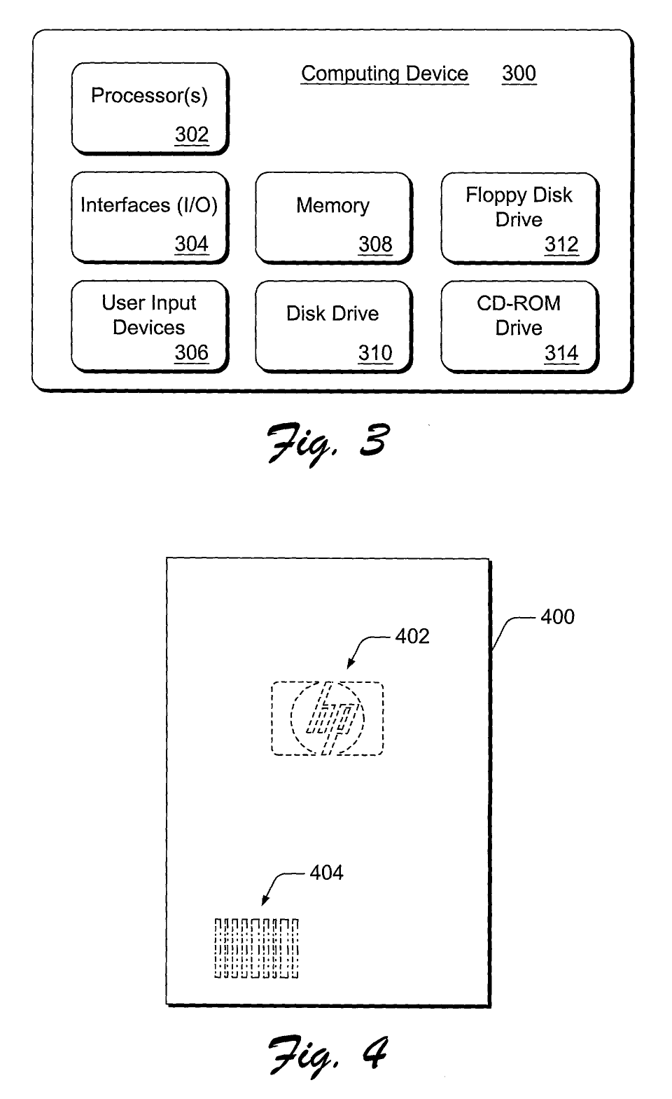

FIG. 2 illustrates a toner cartridge 200 that can be implemented as a component of printing device 100 (FIG. 1). The toner cartridge 200 includes a housing 202 and a toner reservoir 204 that can be filled with laser printer toner. The toner cartridge 200 also includes an identification label 206 that contains information identifying the toner cartridge 200 to a user. The identification label 206 typically indicates the name of the manufacturer, the model number of the cartridge, and the like.

A memory component 208 is located underneath the identification label 206 on the toner cartridge 200, although the memory component 208 can be located on the toner cartridge 200 at any location that will be practical for the purposes described herein. The memory component 208 can be implemented as a radio frequency identification (RFID) memory tag. Those skilled in the art will recognize that RFID memory tags are well known. However, the application of an RFID memory tag as described herein is new.

The memory component 208 integrated with the toner cartridge 200 can be used to store usage data related to the printing device 100 that is collected when the printing device 100 is operational. Information relating to printer usage data stored on a replaceable and/or recyclable component in a printing device can be obtained by the manufacturer when the component is returned to the manufacturer. This provides a printer component manufacturer an opportunity to gather information about how the component has been used, and about the printing device that the component has been installed in.

Most types of printing devices are equipped with replaceable and/or recyclable components that have a life cycle during which the replaceable components are functional. At the end of the life cycle of a replaceable component, the component must be replaced for the printing device to continue to function properly. For example, toner cartridge 200 is a replaceable component of printing device 100, and is recyclable for reuse. Typically, a toner cartridge 200 that has been depleted of toner can be returned and/or exchanged with the manufacturer for a refurbished and ready-to-use toner cartridge.

Replaceable components for the printing devices described herein include, but are not limited to, toner cartridges, ink cartridges, imager drums, fusers, and the like. Although general reference is made to laser printers and toner cartridges, it should be understood that the systems and methods described herein may be utilized with any printing device and with any replaceable component for the printing device.

Exemplary Computer Architecture

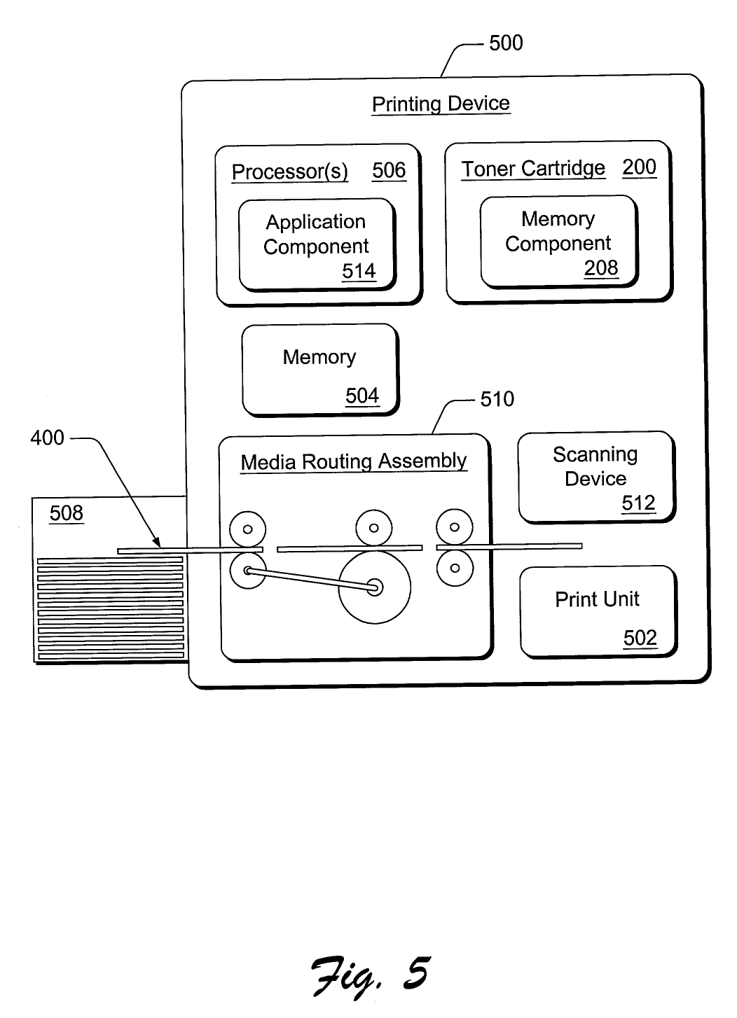

FIG. 3 illustrates various components of an exemplary computing device 300 that can be utilized to implement the inventive techniques described herein. Computer 300 includes one or more processors 302, interfaces 304 for inputting and outputting data, and user input devices 306. Processor(s) 302 process various instructions to control the operation of computer 300, while interfaces 304 provide a mechanism for computer 300 to communicate with other electronic and computing devices. User input devices 306 include a keyboard, mouse, pointing device, or other mechanisms for interacting with, and inputting information to computer 300.

Computer 300 also includes a memory 308 (such as ROM and/or RAM), a disk drive 310, a floppy disk drive 312, and a CD-ROM drive 314. Memory 308, disk drive 310, floppy disk drive 312, and CD-ROM drive 314 provide data storage mechanisms for computer 300. Although not shown, a system bus typically connects the various components within the computing device 300.

Exemplary Print Media

FIG. 4 illustrates a print media 400 that can be routed within a printing device to receive print data corresponding to a print job. The print media 400 can be one of many types of print media, such as recycled paper, pre-punched such as 3-hole, coated print media for differing glosses, transparencies, graphic or chart paper, pre-printed forms, colored paper other than white, different sizes such as 8½×11 or A4, and the like.

A manufacturer of printing devices typically recommends a particular brand of print media for use with the printing devices to obtain an optimum printed output. Different types of print media will render a printed image having varying color distinctions, clarity of the image, sharpness, and the like. Additionally, a particular brand of print media will be less likely to bind or create a paper jam in a particular printing device. Accordingly, a manufacturer of printing devices may also distribute its own brand of print media with various brand types that are designed to provide a high quality print output on all of the various brand types of print media.

The print media 400 has an image that is a media identifier 402 used to identify the print media when it is routed for printing in a printing device. Media identifier 402 is a watermark that is a translucent impression of a distinguishing letter, design, symbol, etc., incorporated into a print media during manufacture. A watermark is visible when the print media is held up to a light, or when viewed from an angle. Those skilled in the art will recognize the various techniques to create watermarks in print media, and the different types of watermarks, such as a two-toned mark having varied dark and light sections, a raised watermark, or a sunken watermark.

Alternatively, or in addition to media identifier 402, print media 400 has a media identifier 404 that is a product barcode implemented as a watermark within the print media. Implementing a distinguishable watermark as a product barcode allows a manufacturer of the print media to identify both the brand of the print media, as well as the various brand types of the print media. Those skilled in the art will recognize that bar code symbology is an implementation of a universal product code (UPC) that is an encoded product identification number that uniquely identifies a particular product, and that there are many different types of product codes and variations of the product codes that can be implemented as a media identifier.

Although the media identifiers 402 and 404 are illustrated having dark outlines in FIG. 4, it is to be understood that the outlines are only shown to represent the media identifiers in the figure, and are thus illustrated as such for representation purposes only. As described above, a watermark is typically only visible when the print media is held up to a light.

The media identifiers 402 and 404 can also be implemented as a printed image on the print media 400, or as any other recognizable identifier that serves to identify the print media. An example of a recognizable media identifier that may not be either an image, or viewable, is a chemical substance. A drop, or pre-determined shape, of a chemical substance can be applied to the print media 400 to identify the print media when the chemical substance is recognized with a chemical detection device, for example.

Print Media Identification in a Printing Device

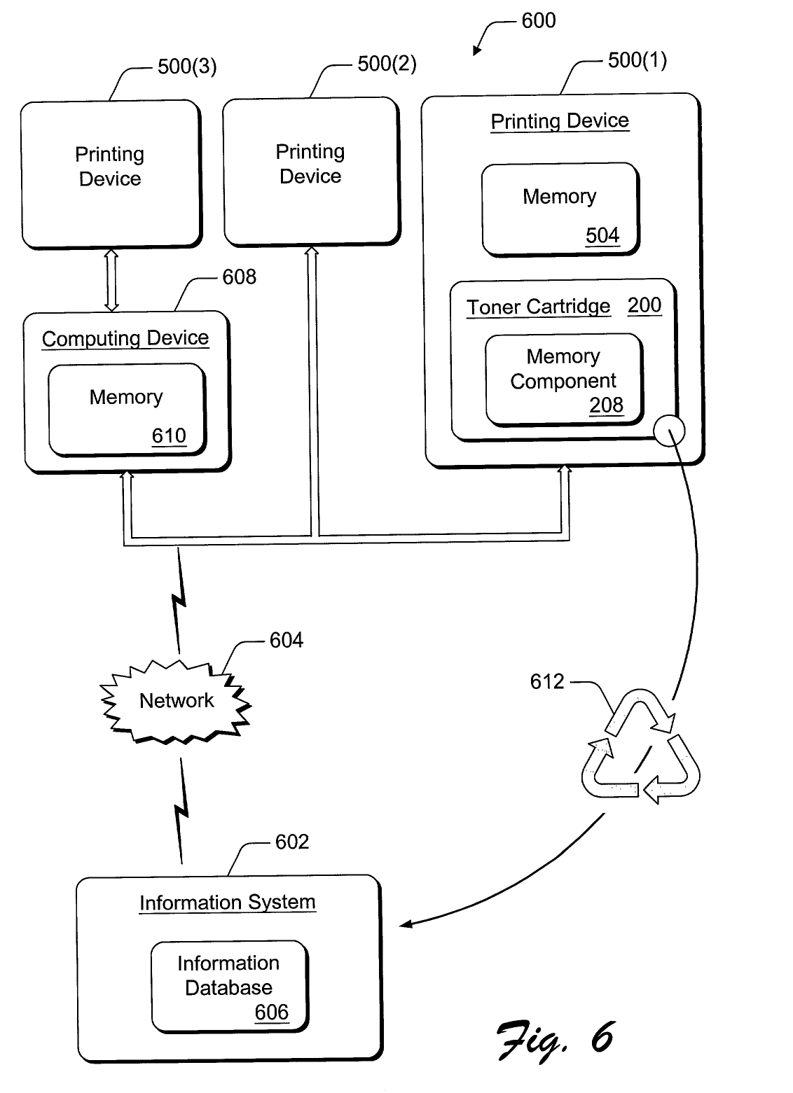

FIG. 5 illustrates a printing device 500 having components to recognize and determine a particular type of print media. The printing device 500 can include one or more of the components of the exemplary printing device 100 (FIG. 1), including a toner cartridge 200 having an integrated memory component 208 (FIG. 2).

The printing device 500 includes a print unit 502, a memory 504, and one or more processors 506. Each of these components are described above with respect to the exemplary printing device 100 (FIG. 1). The printing device 500 also includes a print media container 508, a media routing assembly 510, and a scanning device 512.

The print media container 508 holds print media 400 (FIG. 4) until the media routing assembly 510 takes up a print media and routes it through the printing device 500 for printing. This physical path of the paper through the printer is typically referred to as the “print path” or “print medium path”. When the print media 400 is routed within the printing device 500 by the media routing assembly, the print media 400 passes within a proximity of the scanning device 512.

The scanning device 512 is designed to recognize a media identifier 402 or 404 (FIG. 4) that identifies the print media 400 as it passes the scanning device. The scanning device 512 can be implemented as an optical scanner that recognizes a media identifier, such as an image on the print media, a watermark 402 within the print media, a product barcode implemented as an image on the print media or as a watermark 404 within the print media, or any other type of an identifier that can be recognized as a media identifier. For example, the scanning device 512 can also be implemented as a chemical detection device that recognizes, or detects, a media identifier that is a chemical substance on the print media 400.

The printing device 500 includes an application component 514 that executes on processor 506. The application component 514 receives information corresponding to a media identifier from the scanning device 512 when the scanning device recognizes the media identifier. From the received media identifier information, the application component determines such information as the brand of print media (e.g., the manufacturer, or provider of the print media), and a particular type of the print media. As described above with reference to print media 400 (FIG. 4), a manufacturer may distribute its own brand of print media with various brand types.

The application component 514 also receives information corresponding to the total number of print media that is routed through the printing device 500. Those skilled in the art will recognize that the total number of print media routed through a printer can be obtained from several sources, or locations, within the printer, such as at the print media input to the printer, from within the media routing assembly 510, from the print unit 502 when it prints a page, or at the print media output from the printer.

The application component 514 can determine a percentage of the print media supplied from a particular manufacturer that is used in printing device 500. The percentage can be determined from the received information corresponding to the total number of print media routed through the printing device 500, and the total number of a particular brand and/or type of print media having a recognizable media identifier.

For example, if a manufacturer of printing devices also distributes two types of a particular brand of print media for the printing devices, the manufacturer can determine what percentage of the print media used in the printing devices was distributed by the manufacturer. If two-hundred pages of print media are routed through printing device 500 for printing, and fifty pages of the print media are recognizable as the first type of media via media identifiers, the application component 514 can determine that twenty-five percent of the print media routed through printing device 500 is the first type of the manufacturer's brand. Similarly, if 100 pages of the print media are recognizable as the second type of media via media identifiers, the application component 514 can determine that fifty percent of the print media routed through printing device 500 is the second type of the manufacturer's brand.

The manufacturer obtains the information pertaining to the print media used in a printing device when a replaceable component in the printing device is returned to the manufacturer. For example, the information pertaining to the print media determined by application component 514 can be maintained in memory component 208 that is integrated with toner cartridge 200. When the toner cartridge 200 is depleted of toner, the toner cartridge is returned to the manufacturer for a refurbished cartridge.

Exemplary Print Media Identification and Tracking System

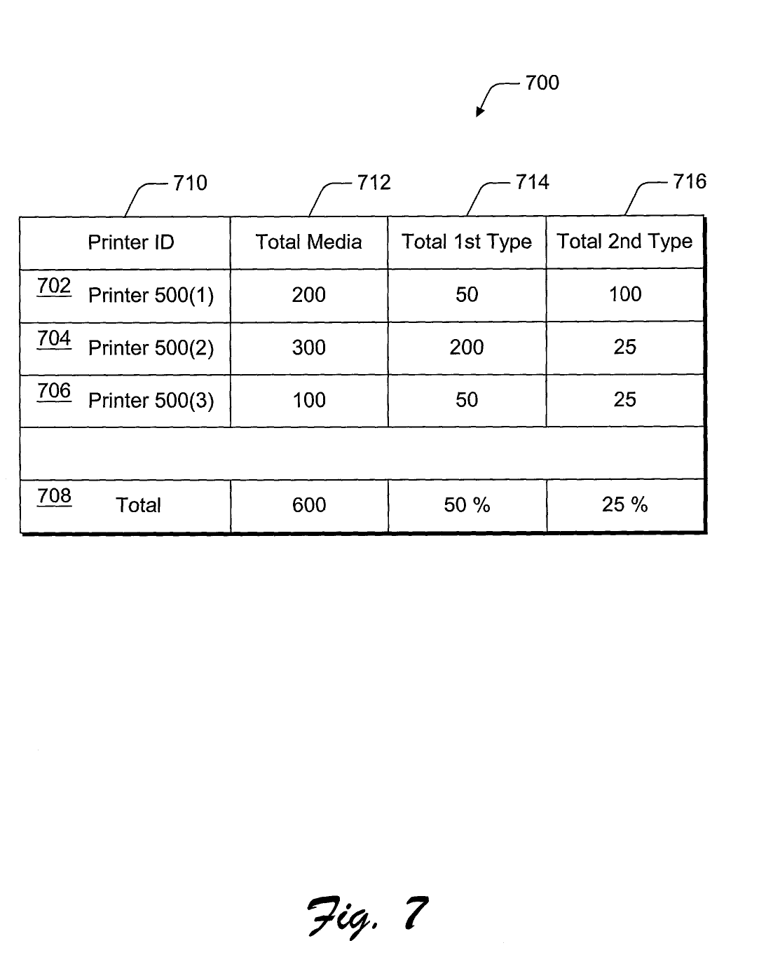

FIG. 6 illustrates components of a network environment 600 in which printing devices 500(1-3) are connected with an information system 602 via a network system 604. The printing devices 500(1-3) are examples of printing device 500 (FIG. 5), and can include one or more of the components of the exemplary printing device 100 (FIG. 1), including a toner cartridge 200 having an integrated memory component 208 (FIG. 2).

The information system 602 represents a manufacturer that has an information database 606 implemented to maintain information pertaining to print media that is routed through printing devices 500(1-3). Those skilled in the art will recognize that information database 606 can include, or be implemented with, one or more of the components of the exemplary computing device 300 (FIG. 3), or with any other computing device, appliance server, and the like. Furthermore, an information database can be implemented with more than one computing device in a distributed network environment.

The network environment 600 includes computing device 608 which is connected to printing device 500(3), and which has a memory component 610. Computing device 608, and memory component 610, can be implemented with one or more of the components of the exemplary computing device 300 (FIG. 3). Although only three printing devices 500(1-3) and one computing device 608 are shown in network environment 600, the network environment can have any number of printing devices and interconnected computing devices. Furthermore, a computing device can be connected to any number of printing devices, and vice-versa.

The network system 604 can be any type of network, such as a local area network (LAN) or a wide area network (WAN), using any type of network topology and any network communication protocol. Although only a few devices are shown interconnected via network system 604, a typical network can have any number of devices connected to it, either directly or indirectly via another network system. The Internet is an example of multiple connected network systems each having multiple devices.

The printing devices 500(1-3) and the various components of the network environment 600 can also have modems and/or network cards that facilitate network communication and data transfer via the network system 604. In addition, the systems and methods described herein can be implemented in distributed computing environments where tasks are performed by remote processing devices that are linked via network system 604. In a distributed computing environment, program modules may be located in both local and remote memory storage devices.

As described above with reference to printing device 500 (FIG. 5), information pertaining to the print media routed through the printing device can be maintained in memory component 208 that is integrated with toner cartridge 200. Additionally, the information can be maintained in a memory component in the printing device, such as in memory component 504 in printing device 500(1).

The information pertaining to the print media routed through printing device 500(3) can be maintained in memory component 610 in computing device 608, as well as in the memory components in printing device 500(3). Furthermore, the information pertaining to the print media routed through any of the printing devices 500(1-3) can be maintained by information system 602 in the information database 606. The information is routed from printing devices 500(1-3) via network system 604 to the information system 602.

As described above, a manufacturer (i.e., information system 602) can also obtain the information pertaining to the print media routed through any of the printing devices 500(1-3) when the toner cartridges 200 are depleted of toner and recycled 612 with the manufacturer for a refurbished cartridge. The manufacturer can combine the information from any number of printing devices 500 in information database 606 to determine what percentage of the print media used in the printing devices was distributed by the manufacturer.

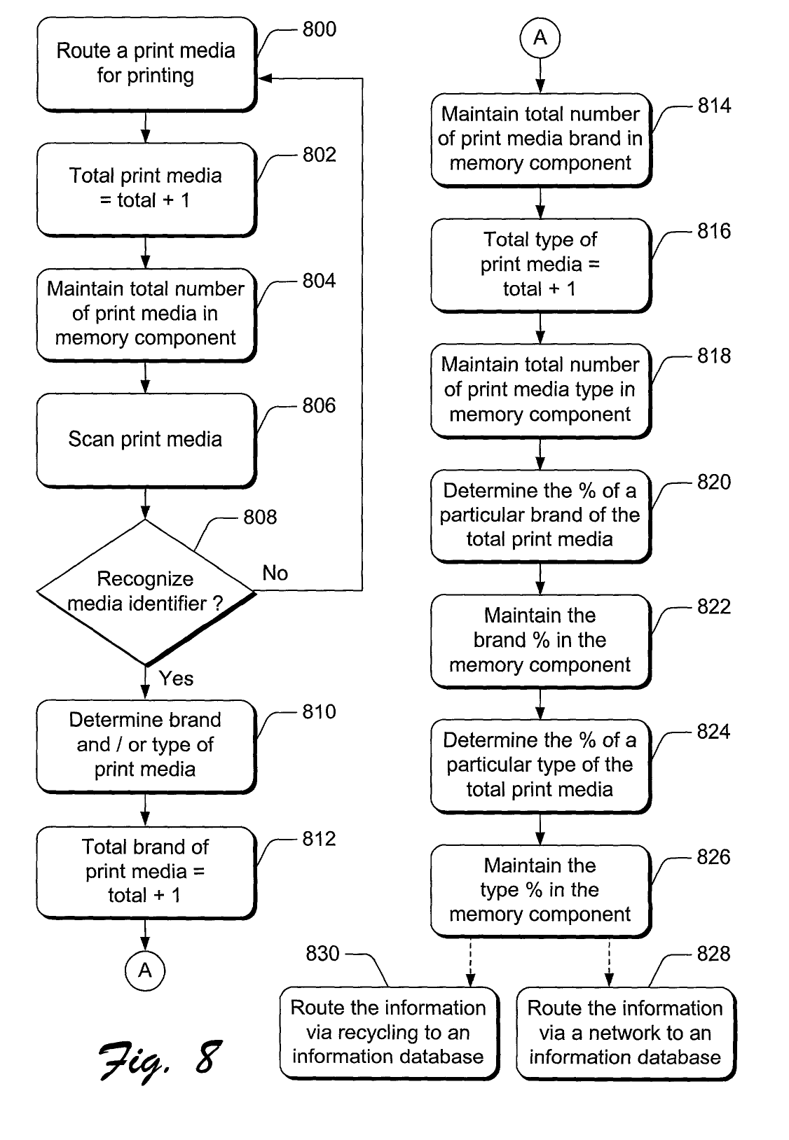

FIG. 7 illustrates a data structure 700 that can be maintained by the information system 602 to store and tabulate the print media information received from the printing devices 500(1-3). The data structure 700 has multiple records represented as records 702 through 708. Each of the records 702, 704, and 706 include a printer identification field 710, a total print media field 712, a total of a first type of print media 714, and a total of a second type of print media 716.

The printer identification field 710 contains a value that uniquely identifies a printing device 500(1-3) in the data structure 700. The printer identification field 710 can contain any numerical or alphanumerical value that uniquely identifies a printing device. Additionally, the combination of records and fields shown in data structure 700 are merely an example to illustrate a print media tracking system for a particular manufacturer, or supplier, of print media. Those skilled in the art will recognize that any combination of records and fields can be created in a data structure to maintain the information described herein.

In this instance, the manufacturer of printing devices 500(1-3) (FIG. 6) also distributes two types of a particular brand of print media for the printing devices. Record 702 illustrates that a total of two-hundred pages of print media 712 have been routed through printing device 500(1) for printing, and fifty pages of the print media are the first type of print media 714 that the manufacturer distributes. Similarly, one-hundred pages of the print media are the second type of print media 716 that the manufacturer distributes.

Record 704 illustrates that a total of three-hundred pages of print media have been routed through printing device 500(2), where two-hundred pages of the print media are the first type of print media, and twenty-five pages of the print media are the second type of print media that the manufacturer distributes. Record 706 illustrates that a total of one-hundred pages of print media have been routed through printing device 500(3), where fifty pages of the print media are the first type of print media, and twenty-five pages of the print media are the second type of print media that the manufacturer distributes. Note that a user of a printing device does not necessarily use the brand and/or type of print media recommended by a manufacturer of a printing device. Accordingly, the total of the first type of print media and the second type of print media may not equal the total pages of print media routed through a particular printing device.

Record 708 illustrates that a total of six-hundred pages of print media have been routed through printing devices 500(1-3). Fifty percent of the print media routed through printing devices 500(1-3) was the first type of the manufacturer's brand of print media, and twenty-five percent of the print media routed through printing devices 500(1-3) was the second type of the manufacturer's brand of print media. With this information, the manufacturer can determine its market share of print media used in the manufacturer's printing devices.

Method for Determining Print Media Types

FIG. 8 illustrates a method for determining different print media types and storing corresponding information for market and product analysis. The order in which the method is described is not intended to be construed as a limitation. Furthermore, the method can be implemented in any suitable hardware, software, firmware, or combination thereof.

At block 800, a printing device routes a print media for printing within the printing device. The print media has a media identifier that identifies the brand and/or type of the print media. For example, print media 400 (FIG. 4) has a media identifier that is a watermark 402. Alternatively, or in addition to the watermark 402, print media 400 can have a media identifier that is a product barcode implemented as a watermark 404.

At block 802, a counter, or similar additive device, is incremented to determine a total number of print media routed in the printing device. At block 804, a number or value that represents the total number of print media routed in the printing device is maintained in a memory component. The memory component can be integrated with a replaceable component of the printing device, such as memory component 208 integrated with toner cartridge 200. Additionally, the memory component can be a component of the printing device, such as memory 504 in printing device 500, or the memory component can be a component of a computing device connected to the printing device, such as memory component 610 in computing device 608. These memory component examples pertain to “the memory component” referenced in the following discussion.

At block 806, a scanning device scans the print media as it is being routed within the printing device. The scanning device can be implemented as an optical scanner to recognize a media identifier that is an image on the print media, or a watermark within the print media. The scanning device can also be implemented as a chemical detection device to recognize a media identifier that is a chemical substance on the print media.

If the scanning device recognizes a media identifier when scanning the print media (i.e., “yes” from block 808), an application component, such as a software program for example, determines the brand and/or type of the print media from the media identifier at block 810. The application component receives information corresponding to a media identifier from the scanning device when the scanning device recognizes a media identifier in the print media. If the scanning device does not recognize a media identifier when scanning the print media (i.e., “no” from block 808), the method returns to block 800.

At block 812, a number representing the total number of a particular brand of print media routed in the printing device is incremented, and the number is maintained in the memory component at block 814. At block 816, a number representing the total number of a particular type of print media routed in the printing device is incremented, and the number is maintained in the memory component at block 818.

At block 820, a percentage of the total number of a particular brand of print media to the total number of print media routed in the printing device is determined. The percentage is determined from the information pertaining to the total number of print media routed in the printing device, and the total number of a particular brand of print media, stored in the memory component. At block 822, a value representing the percentage of a particular brand of print media is maintained in the memory component.

At block 824, a percentage of the total number of a particular type of print media to the total number of print media routed in the printing device is determined. The percentage is determined from the information pertaining to the total number of print media routed in the printing device, and the total number of a particular type of print media, stored in the memory component. At block 826, a value representing the percentage of a particular type of print media is maintained in the memory component.

At blocks 828 and/or 830, the information maintained in the memory component is routed to an information database located remotely from the printing device. In this instance, the information database represents a manufacturer of the printing device, where the manufacturer also supplies the print media for use with the printing device. If the memory component maintaining the information is a component of the printing device, or a component of a computing device connected to the printing device, the information can be routed to the information database from the printing device via a network system at block 828. If the memory component maintaining the information is integrated with a replaceable component of the printing device, the information can be routed to the information database via a component replacement and recycle program at block 830.

Conclusion

A system for determining different print media brands and brand types as the print media is routed within printing devices facilitates a manufacturer of the printing devices to determine what percentage of the print media used in the printing devices was distributed by the manufacturer. Determining the manufacturer's percentage of the print media used in the printing devices helps the manufacturer to prepare marketing strategies and product distribution schemes, particularly for printing devices and print media recommended for use within the printing devices.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A printing device, comprising:
a media routing assembly configured to route a print media for printing;
a scanning device configured to recognize a media identifier that identifies the print media when the print media is routed by the media routing assembly;
an application component configured to determine a brand of the print media from the recognized media identifier.

2. A printing device as recited in claim 1, further comprising a memory component configured to maintain information corresponding to a total number of print media routed by the media routing assembly, and a total number of a particular brand of print media having a recognizable media identifier.

3. A printing device as recited in claim 1, further comprising a memory component integrated with a replaceable component of the printing device, the memory component configured to maintain information corresponding to a total number of print media routed by the media routing assembly, and a total number of a particular brand of print media having a recognizable media identifier.

4. A printing device as recited in claim 1, wherein the application component is further configured to determine a type of the print media from the recognized media identifier.

5. A printing device as recited in claim 1, further comprising a memory component configured to maintain information corresponding to a total number of print media routed by the media routing assembly, wherein the application component is further configured to determine a type of the print media from the recognized media identifier, and wherein the memory component is further configured to maintain information corresponding to a total number of a particular brand and a particular type of print media having a recognizable media identifier.

6. A printing device as recited in claim 1, wherein the scanning device is an optical scanner configured to recognize the media identifier, and wherein the media identifier is an image on the print media.

7. A printing device as recited in claim 1, wherein the scanning device is an optical scanner configured to recognize the media identifier, and wherein the media identifier is a watermark.

8. A printing device as recited in claim 1, wherein the scanning device is an optical scanner configured to recognize the media identifier, and wherein the media identifier is a product barcode implemented as a watermark.

9. A printing device as recited in claim 1, wherein the scanning device is a chemical detection device configured to recognize the media identifier, and wherein the media identifier is a chemical substance on the print media.

10. A printing device as recited in claim 1, wherein the application component is further configured to determine a percentage of a total number of a particular brand of print media having a recognizable media identifier to a total number of print media routed by the media routing assembly.

11. A printing device as recited in claim 1, further comprising a memory component configured to maintain information corresponding to a total number of print media routed by the media routing assembly, a total number of a particular brand of print media having a recognizable media identifier, and a percentage of the total number of a particular brand of print media to the total number of print media, wherein the application component is further configured to determine the percentage.

12. A system, comprising:
a plurality of printing devices, wherein an individual printing device comprises:
a media identification component configured to recognize a media identifier that identifies a print media when the print media is routed for printing within the printing device;
an application component configured to determine a type of the print media from the recognized media identifier; and
an information database configured to maintain information from the plurality of printing devices, the information corresponding to a total number of print media routed for printing, and a total number of a particular type of print media having a recognizable media identifier.

13. A system as recited in claim 12, further comprising a network communication system configured to connect the plurality of printing devices with the information database, wherein the information database is remotely located from the printing devices.

14. A system as recited in claim 12, wherein an individual printing device further comprises a memory component configured to maintain the information for the individual printing device.

15. A system as recited in claim 12, wherein an individual printing device further comprises a memory component integrated with a replaceable component of the individual printing device, the memory component configured to maintain the information for the individual printing device.

16. A system as recited in claim 12, further comprising a computing device connected to one or more of the plurality of printing devices, the computing device comprising a memory component configured to maintain the information for the one or more printing devices.

17. A system as recited in claim 12, wherein the media identification component is an optical scanner configured to recognize the media identifier, and wherein the media identifier is an image on the print media.

18. A system as recited in claim 12, wherein the media identification component is an optical scanner configured to recognize the media identifier, and wherein the media identifier is a watermark.

19. A system as recited in claim 12, wherein the media identification component is an optical scanner configured to recognize the media identifier, and wherein the media identifier is a product barcode implemented as a watermark.

20. A system as recited in claim 12, wherein the media identification component is a chemical detection device configured to recognize the media identifier, and wherein the media identifier is a chemical substance on the print media.

21. A system as recited in claim 12, wherein the information database is further configured to maintain information corresponding to a percentage of the total number of a particular type of print media to the total number of print media.

22. A method, comprising:
routing a print media in a printing device;
determining a type of the print media from a media identifier when said routing the print media; and
maintaining information with a memory component, the information corresponding to a total number of print media routed in the printing device and a total number of a particular type of print media having a determinable media identifier.

23. A method as recited in claim 22, further comprising determining the total number of print media routed in the printing device, and determining the total number of a particular type of print media having a determinable media identifier.

24. A method as recited in claim 22, further comprising determining a percentage of the total number of a particular type of print media to the total number of print media routed in the printing device.

25. A method as recited in claim 22, further comprising:
determining the total number of print media routed in the printing device;
determining the total number of a particular type of print media having a determinable media identifier; and
determining a percentage of the total number of a particular type of print media to the total number of print media.

26. A method as recited in claim 22, further comprising determining a brand of the print media from the media identifier when said routing the print media.

27. A method as recited in claim 22, further comprising:
determining a brand of the print media from the media identifier when said routing the print media;
determining the total number of print media routed in the printing device;
determining a total number of a particular brand and particular type of print media having a determinable media identifier; and
determining a percentage of the total number of a particular brand and particular type of print media to the total number of print media.

28. A method as recited in claim 22, further comprising determining a brand of the print media from the media identifier when said routing the print media, and maintaining information corresponding to a total number of a particular brand and particular type of print media having a determinable media identifier.

29. A method as recited in claim 22, further comprising obtaining the information from the memory component, and storing the information in an information database.

30. A method as recited in claim 22, wherein said determining comprises scanning the print media with an optical scanner configured to recognize the media identifier, and wherein the media identifier is an image on the print media.

31. A method as recited in claim 22, wherein said determining comprises scanning the print media with an optical scanner configured to recognize the media identifier, and wherein the media identifier is a watermark.

32. A method as recited in claim 22, wherein said determining comprises scanning the print media with an optical scanner configured to recognize the media identifier, and wherein the media identifier is a product barcode implemented as a watermark.

33. A method as recited in claim 22, wherein said determining comprises scanning the print media with a chemical detection device configured to recognize the media identifier, and wherein the media identifier is a chemical substance on the print media.

34. A method as recited in claim 22, wherein the memory component is integrated with a replaceable component of the printing device.

35. A method as recited in claim 22, wherein the memory component is integrated with a computing device connected to the printing device.

36. A computer-readable medium comprising computer executable instructions that, when executed, direct a computing system to perform a method comprising:
determining a brand of a print media from a media identifier when routing the print media in a printing device;
determining a type of the print media from the media identifier;
determining a total number of print media routed in the printing device;
determining a total number of a particular brand and particular type of print media having a determinable media identifier; and
determining a percentage of the total number of a particular brand and particular type of print media to the total number of print media.

37. One or more computer-readable media as recited in claim 36, wherein the method further comprises maintaining information with a memory component, the information corresponding to the total number of print media routed in the printing device, the total number of a particular brand and particular type of print media, and the determined percentage.
